(19) United States
(12) Patent Application Publication
(10) Pub. No.: US 2009/0083799 A1
(43) Pub. Date: Mar. 26, 2009

(54) BROADCAST RECEIVING APPARATUS

(76) Inventor: Yosuke Sakasegawa, Osaka (JP)

Correspondence Address: MORGAN LEWIS & BOCKIUS LLP, 1111 PENNSYLVANIA AVENUE NW, WASHINGTON, DC, 20004, US

(21) Appl. No.: 12/208,676

(22) Filed: Sep. 11, 2008

(30) Foreign Application Priority Data
Sep. 26, 2007 (JP) 2007-249686

(51) Int. Cl. H04N 5/445

(52) U.S. Cl. 725/53

(57) ABSTRACT

If a keyword determining portion judges that the program name or program information of the selected program contains the keyword registered in a nonvolatile memory, a muting portion makes a video processing portion and an audio processing portion stop outputting a video signal and an audio signal, respectively. As a result of this muting processing, no video is displayed on the display device, and no sound is outputted from a loudspeaker. If the keyword determining portion judges that the program name or program information of the selected program does not contain the keyword registered in the nonvolatile memory, the video processing portion and the audio processing portion output the video signal and the audio signal, respectively, as usual. Consequently, video is displayed on the display device, and sound is outputted from the loudspeaker.

This application is based on Japanese Patent Application No. 2007-249686 filed on Sep. 26, 2007, the contents of which are hereby incorporated by reference.

### BACKGROUND OF THE INVENTION

1. Field of the Invention

The present invention relates to a broadcast receiving apparatus including an analog tuner receiving an analog broadcast signal from a selected analog television station and a digital tuner receiving a digital broadcast signal from a selected terrestrial digital television station, the broadcast receiving apparatus that can output a video/audio signal of an analog broadcast program or a video/audio signal of a digital broadcast program, and more particularly to a mute function of stopping video/audio of a viewing restricted program.

2. Description of Related Art

In a case where a television receiver is provided with a broadcast receiving apparatus that can output a video/audio signal of an analog broadcast program or a video/audio signal of a digital broadcast program, the user can view a desired program with this television receiver. However, some programs are not suitable to be viewed by a certain member of the family, for example, children. In particular, parents usually do not want their children to view a program including a scene that is detrimental to education, such as a murder, violence, or obscene scene. Therefore, the broadcast receiving apparatus is required to have a viewing restriction function of blocking the viewing of a program that is inappropriate for children, for example. In particular, it is preferable that this viewing restriction function can stop the output of video and audio signals.

For this reason, the conventional technology of JP-A-2000-174649 (hereinafter “Patent Document 1”) realizes a viewing restriction function by disabling the showing of the program information of a program that matches a genre set by the user, or by making it impossible to select a channel of a program if genre information matches.

The conventional technology of JP-A-2005-136519 (hereinafter “Patent Document 2”) realizes a viewing restriction function by imposing viewing restrictions and imposing restrictions on the display of the electronic program guide if a keyword set by the user matches the program information containing a program name or the like.

The conventional technology of JP-A-2003-219300 (hereinafter “Patent Document 3”) realizes a viewing restriction function by displaying, if the electronic program information of a program is found to contain a keyword set by the user, that program in the EPG in a color different from other programs, or sounding a warning beep if the program selected by the user contains rating information.

The conventional technology of JP-A-2006-254257 (hereinafter “Patent Document 4”) realizes a viewing restriction function of imposing restrictions on the viewing based on the set keyword when recording a television program.

The conventional technology of JP-B-3536948 (hereinafter “Patent Document 5”) realizes a viewing restriction function by preventing individuals targeted for viewing restriction from viewing a viewing restricted program when displaying the electronic program guide.

Although, as described above, the conventional technology of Patent Document 1 makes it possible to disable the showing of the program information of a program that matches a genre set by the user, if the user forgets what genre of program he/she has selected, the user feels inconvenience. Incidentally, this conventional technology is applied to a receiver receiving digital broadcasting, and is not applied to a receiver receiving analog broadcasting. In addition, this conventional technology does not disclose a viewing restriction function of stopping the output of the video and audio signals.

Although, as described above, the conventional technology of Patent Document 2 imposes viewing restrictions and imposes restrictions on the display of the electronic program guide if a keyword set by the user matches the program information containing a program name or the like, a viewing restriction function of stopping the output of the video and audio signals is not disclosed.

Although, as described above, the conventional technology of Patent Document 3 displays, if the electronic program information of a program is found to contain a keyword set by the user, that program in the EPG in a color different from other programs, or sounds a warning beep if the program selected by the user contains rating information, a viewing restriction function of stopping the output of the video and audio signals is not disclosed. Incidentally, this conventional technology is applied to a receiving apparatus receiving digital broadcasting, and is not applied to a receiving apparatus receiving analog broadcasting.

Although, as described above, the conventional technology of Patent Document 4 imposes restrictions on the viewing based on the set keyword when recording a television program, a viewing restriction function of stopping the output of the video and audio signals is not disclosed.

Although, as described above, the conventional technology of Patent Document 5 prevents individuals targeted for viewing restriction from viewing a viewing restricted program when displaying the electronic program guide, a viewing restriction function of stopping the output of the video and audio signals is not disclosed.

### SUMMARY OF THE INVENTION

In view of the problems described above, an object of the present invention is to provide a broadcast receiving apparatus that can stop a video signal and an audio signal when a program having a program name and program information containing a keyword registered by the user.

To achieve the above object, according to one aspect of the present invention, in a broadcast receiving apparatus provided with: an analog tuner receiving an analog broadcast signal from a selected analog television station; a digital tuner receiving a digital broadcast signal from a selected terrestrial digital television station; video processing system and audio processing system outputting a video/audio signal of an analog broadcast program or a video/audio signal of a digital broadcast program; and a memory, the broadcast receiving apparatus is provided with: a keyword registering portion registering a keyword in the memory, the keyword presumed to be contained in a program name or program information of a program on which viewing restrictions are imposed, in response to inputting of the keyword; a password registering portion registering, in the memory, a password for lifting viewing restrictions imposed on a viewing restricted program in response to inputting of the password; a keyword determining portion determining, if a program that is receivable by channel selection of the analog tuner or channel selection of the digital tuner is selected by key operation or operation performed for an electronic program guide, whether or not a program name or program information of the selected program contains the keyword registered in the memory; and a muting portion making the video processing system and the audio processing system stop outputting the video signal and the audio signal, respectively, if the program name or program information of the selected program is found to contain the keyword registered in the memory.

With this configuration, if a program that is receivable by channel selection of the analog tuner or channel selection of the digital tuner is selected by key operation or operation performed for the electronic program guide, determination as to whether or not a program name or program information of the selected program contains the keyword registered in the memory is made. If the program name or program information of the selected program is found to contain the keyword registered in the memory, the video processing system and the audio processing system are made to stop outputting the video signal and the audio signal, respectively.

With this configuration, it is possible to stop the output of the video signal and the audio signal if a program having a program name or program information containing a keyword registered by the user is selected. This makes it possible to block the viewing of a harmful program the user does not want children, for example, to view.

In addition, according to the invention, the broadcast receiving apparatus is provided with a setting screen display portion making a display device display a keyword/password setting screen for registering the keyword and the password in the memory. This makes it possible to easily register the keyword and the password.

Moreover, according to the invention, the broadcast receiving apparatus is provided with: a password determining portion determining, when detecting inputting of a password by user operation, whether or not the inputted password matches the password registered in the memory; and an unmuting portion terminating suspension of output of the video signal and the audio signal if the inputted password is found to match the registered password. This makes it possible to terminate suspension of output by inputting the user's password.

As described above, according to the invention, it is possible to stop the output of a video signal and an audio signal if a program having a program name or program information containing a keyword registered by the user is selected. This makes it possible to block the viewing of a harmful program the user does not want children, for example, to view.

### BRIEF DESCRIPTION OF THE DRAWINGS

FIG. 1 is a block diagram showing the configuration of a television receiver incorporating a broadcast receiving apparatus according to an embodiment of the invention;

FIG. 2 is a diagram showing an example of the keyword/password setting screen in the embodiment;

FIG. 3 is a flow chart illustrating the procedure by which a keyword and a password are registered in the embodiment; and

FIG. 4 is a flow chart illustrating video/audio muting processing and unmuting processing in the embodiment.

### DETAILED DESCRIPTION OF PREFERRED EMBODIMENTS

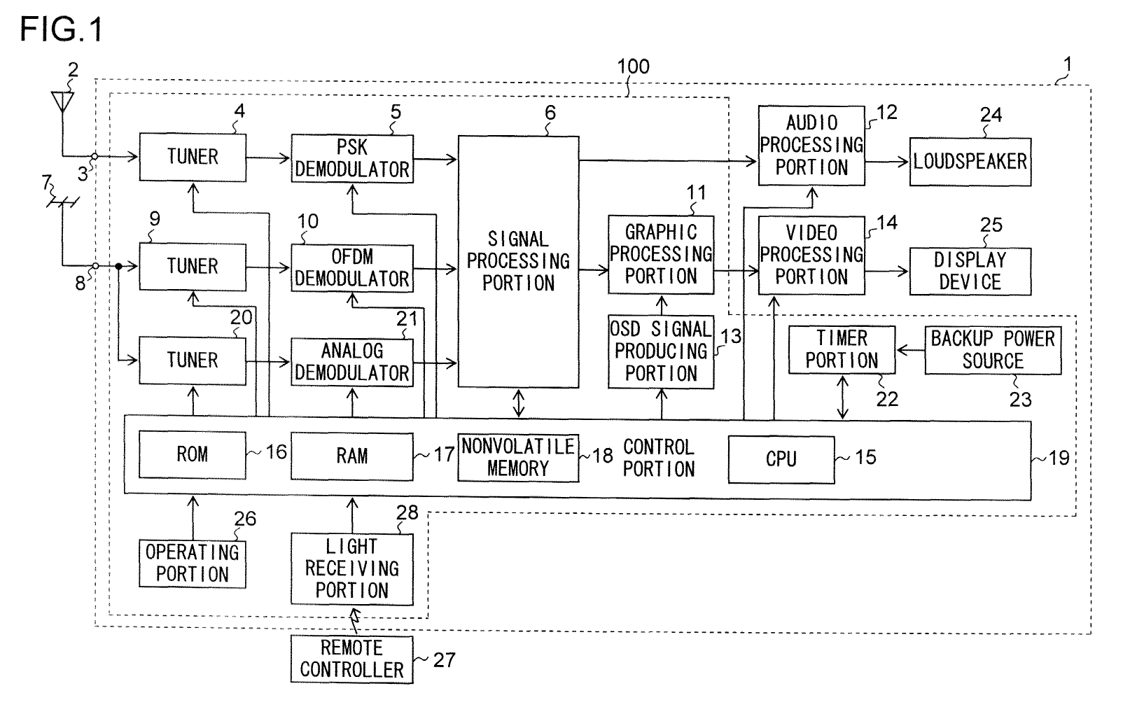

Hereinafter, preferred embodiments of the present invention will be described with reference to accompanying drawings. FIG. 1 is a block diagram showing the configuration of a television receiver incorporating a broadcast receiving apparatus according to an embodiment of the invention. Although a description will be given below of the configuration in which the broadcast receiving apparatus embodying the invention is incorporated into the television receiver, it is also possible to incorporate the broadcast receiving apparatus embodying the invention into information recording/playback devices such as DVD recorders, BD recorders, or hard disk recorders.

In FIG. 1, a television receiver 1 incorporates a broadcast receiving apparatus 100. The broadcast receiving apparatus 100 includes am input terminal 3 connected to an antenna 2 for receiving BS (broadcast satellite)/CS (communication satellite) digital broadcasting, a BS/CS tuner 4 connected to the input terminal 3, a PSK (phase shift keying) demodulator 5 connected to the BS/CS tuner 4, a signal processing portion 6 connected to the PSK demodulator 5, an input terminal 8 connected to an antenna 7 for receiving terrestrial digital broadcasting, a tuner (hereinafter a “digital tuner”) 9 for receiving terrestrial digital broadcasting, the tuner 9 connected to the input terminal 8, an OFDM (orthogonal frequency division multiplexing) demodulator 10 connected to the digital tuner 9 and the signal processing portion 6, a graphic processing portion 11 connected to the signal processing portion 6, an audio processing portion (audio processing system) 12 connected to the signal processing portion 6, and an OSD (on screen display) signal processing portion 13 connected to the graphic processing portion 11. The television receiver 1 includes a video processing portion (video processing system) 14 connected to the graphic processing portion 11.

The broadcast receiving apparatus 100 also includes a control portion 19 that has a CPU 15 performing computational operation and control, a ROM 16 storing a control program executed by the CPU 15, a RAM 17 temporarily storing data required for operation of the CPU 15, and a nonvolatile memory 18 storing various setting information and control information, and that performs overall control of the television receiver 1. In addition, the broadcast receiving apparatus 100 includes a tuner (hereinafter an “analog tuner”) 20 for analog broadcasting, the tuner 20 connected to the input terminal 8, an analog demodulator 21 connected to the analog tuner 20 and the signal processing portion 6, a timer portion 22 connected to the control portion 19, and a backup power source 23 supplying power to the timer portion 22.

Used as the antenna 2 is, in general, a parabolic antenna, and used as the antenna 7 is, for example, a Yagi antenna for receiving terrestrial waves. The BS/CS tuner 4 is a tuner for receiving satellite digital broadcasting, and is controlled by the control portion 19 so as to perform channel selection and receive a satellite digital television broadcasting signal. The PSK demodulator 5 demodulates the satellite digital television broadcasting signal into a digital video signal and a digital audio signal.

The digital tuner 9 is a tuner for receiving terrestrial digital broadcasting, and is controlled by the control portion 19 so as to perform channel selection and receive a terrestrial digital television broadcasting signal. The OFDM demodulator 10 demodulates the terrestrial digital television broadcasting signal into a digital video signal and a digital audio signal.

The analog tuner 20 is a conventional tuner for receiving analog broadcasting, and is controlled by the control portion 19 so as to perform channel selection and receive an analog television broadcasting signal. The analog demodulator 21 demodulates the analog television broadcasting signal into an analog video signal and an analog audio signal.

The signal processing portion 6 selectively performs predetermined digital signal processing for the digital video and audio signals fed from the PSK demodulator 5 and for the digital video and audio signals fed from the OFDM demodulator 10, and outputs the resultant signals to the graphic processing portion 11 and the audio processing portion 12. In addition, the signal processing portion 6 converts the signals demodulated by the analog demodulator 21 into digital signals, and outputs them to the graphic processing portion 11 and the audio processing portion 12.

The graphic processing portion 11 superimposes an OSD signal produced by the OSD signal producing portion 13 on the digital video signal from the signal processing portion 6, and outputs the resultant signal. In addition, the graphic processing portion 11 selectively outputs the video signal from the signal processing portion 6 and the OSD signal from the OSD signal producing portion 13, or outputs these signals such that screens based thereon each occupy a corresponding half of the screen.

The audio processing portion 12 of the television receiver 1 converts the digital audio signal from the signal processing portion 6 into an analog audio signal such that the loudspeaker 24 of the television receiver 1 can convert it to sound, and amplifies the analog audio signal and outputs the resultant signal. The video processing portion 14 of the television receiver 1 converts the digital video signal from the graphic processing portion 11 into an analog video signal in a format that can be displayed by the display device 25 of the television receiver 1, and outputs it to the display device 25.

The control portion 19 receives an operation signal from an operating portion 26, or receives an infrared operation signal from a remote controller 27 via a light receiving portion 28, and performs control based on the operation signal thus received. The timer portion 22 has a real-time clock function of producing a reference clock signal with a quartz oscillator circuit, a frequency divider circuit, and the like, and producing time information based on the reference clock signal thus produced, an automatic running function of operating independently, and a function of allowing time information to be updated from outside (a function of updating the current time measured by the timer portion 22 in accordance with time information contained in the analog broadcast signal or the digital broadcast signal). At power off, the timer portion 22 operates by using the backup power source 23 as a power source thereof, and continues timer operation even if power to the television receiver 1 is turned off.

The CPU 15 of the control portion 19 includes: a keyword registering portion that registers a keyword in the nonvolatile memory 18, the keyword presumed to be contained in the program name or program information of a program on which the user wishes to impose viewing restrictions, in response to the inputting of that keyword; a password registering portion that registers, in the nonvolatile memory 18, a password for lifting the viewing restrictions on the viewing restricted program in response to the inputting of that password; a keyword determining portion that determines, if a program selected by the channel selection of the analog tuner 20 or the digital tuner 9 is selected by direct key operation or operation performed for the electronic program guide, whether or not the program name or program information of the selected program contains the keyword registered in the nonvolatile memory 18; a muting portion that makes the video processing portion 14 serving as a video processing system and the audio processing portion 12 serving as the audio processing system stop outputting the video signal and the audio signal, respectively, if it is found that the program name or program information of the selected program contains the keyword registered in the nonvolatile memory 18; a password determining portion that determines, if a password is inputted by user operation, whether or not the inputted password matches the registered password registered in the nonvolatile memory 18; an unmuting portion that terminates suspension of output of the video signal and the audio signal if it is found that the inputted password matches the registered password; and a setting screen display portion that makes the display device 25 display a keyword/password setting screen such that the keyword and the password are registered in the nonvolatile memory 18.

Next, the overall operation of the television receiver 1 will be described. When the user depresses the power key of the operating portion 26 or the remote controller 27, the power to the television receiver 1 is turned on. In a case where the power is turned on, for example, immediately after the purchase of the television receiver 1 or after the television receiver 1 is left untouched with the power cord removed from the receptacle, when the user sets time information by using the remote controller 27, this time information is stored in the RAM 17 by the control portion 19, and is then read therefrom to perform time setting for the timer portion 22. Thereafter, the timer portion 22 runs automatically, and continuously performs timer operation while performing an update by receiving time information contained in the digital broadcast signal received by the BS/CS tuner 4 or the digital tuner 9 or time information contained in the analog broadcast signal received by the analog tuner 20, so as to keep the current time up-to-date.

Here, if the user operates the remote controller 27 and selects any one of BS/CS digital broadcasting, terrestrial digital broadcasting, and analog broadcasting, the control portion 19 brings a corresponding one of the tuners 4, 9, and 20 into an operating state according to this selection. For example, in a case where BS/CS digital broadcasting is selected, the digital television broadcast signal received by the antenna 2 is inputted to the BS/CS tuner 4. When the user selects a desired channel, a broadcast signal of that channel is inputted to the PSK demodulator 5. After demodulating the broadcast signal into a digital video signal, a digital audio signal, and a data signal, the PSK demodulator 5 outputs the demodulated signals to the signal processing portion 6.

The terrestrial digital television broadcast signal and the analog television broadcast signal received by the antenna 7 are inputted to the digital tuner 9 and the analog tuner 20, respectively. The terrestrial digital broadcast signal subjected to channel selection by the digital tuner 9 is demodulated by the OFDM demodulator 10 into a digital video signal, a digital audio signal, and a data signal, and the resultant signals are outputted to the signal processing portion 6. The terrestrial analog broadcast signal subjected to channel selection by the analog tuner 20 is demodulated into an analog video signal, an analog audio signal, and a data signal by the analog demodulator 21, and the resultant signals are outputted to the signal processing portion 6.

The signal processing portion 6 performs predetermined digital signal processing for the video signal and the audio signal of the demodulated signals received from the reception side on a broadcasting system-by-broadcasting system basis, and outputs the video signal and the audio signal thus processed to the graphic processing portion 11 and the audio processing portion 12, respectively. In addition, the signal processing portion 6 extracts time information from information of BS data broadcasting or terrestrial data broadcasting, and temporarily stores it in the RAM 17 provided in the control portion 19. The control portion 19 reads the time information of the automatically running timer portion 22, and compares it with the time information obtained from the data broadcasting. If the comparison shows that there is a difference between them, the control portion 19 retrieves from the RAM 17 the time information obtained from the data broadcasting, and sets it in the timer portion 22. That is, the control portion 19 corrects time such that time measured by the timer portion 22 becomes identical to the correct current time.

In a case where the power to the television receiver 1 is turned off or the power cord thereof is removed from the receptacle, or reception of digital broadcasting becomes poor due to rainfall, snowfall, or ellipse of the moon, it becomes impossible to obtain time information by digital broadcasting, causing time updates of the timer portion 22 to stop. However, even when the power is turned off the timer portion 22 is supplied with power from the backup power source 23, and the function of the timer portion 22 is maintained. This allows the time information to be updated. When the power is restored after power off the control portion 19 retrieves time information from the timer portion 22, and outputs it to the OSD signal producing portion 13. The OSD signal producing portion 13 converts the time information into textual information, and outputs it to the graphic processing portion 11. The graphic processing portion 11 superimposes the textual information on the video signal from the signal processing portion 6, and the video processing portion 14 performs color adjustment. The video signal thus obtained is displayed by the display device 25 as time information.

The digital video signal from the graphic processing portion 11 is converted by the video processing portion 14 into an analog video signal in a format that can be displayed by the display device 25, and is then inputted to the display device 25. In addition, the audio processing portion 12 converts the digital audio signal from the signal processing portion 6 into an analog audio signal, and drives the loudspeaker 24 with this analog audio signal such that sound is outputted from the loudspeaker 24.

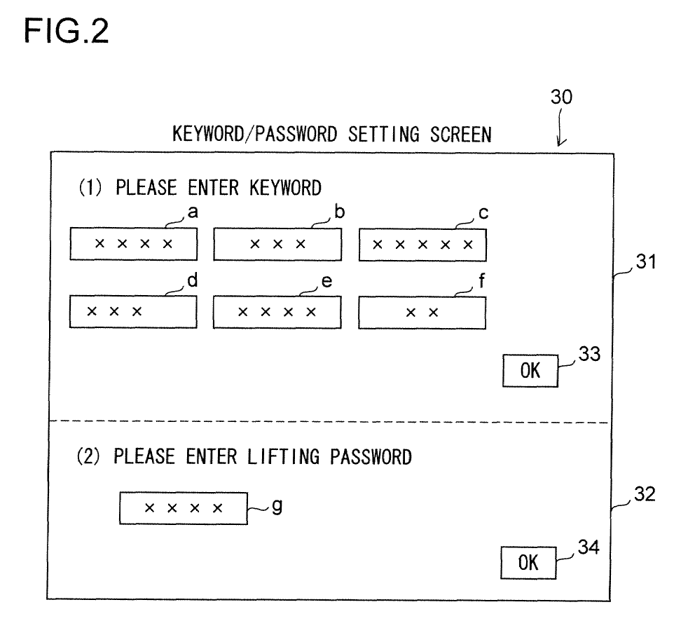

FIG. 2 is a diagram showing an example of the keyword/password setting screen in the embodiment. In FIG. 2, the keyword/password setting screen 30 has, for example, a region 31 for allowing the main user of the family to input a keyword for imposing viewing restrictions on a program the user does not wish children, for example, to view, and a region 32 for allowing the user to input a password for lifting the viewing restrictions. Used as the keyword is a word presumed to be contained in the program name or program information of a program on which the main user wishes to impose viewing restrictions. The program information includes a word used for a scene that is detrimental to education, such as a murder, violence, or obscene scene.

The message in the region 31 reads, “PLEASE ENTER KEYWORD”, and the keywords “a”, “b”, “c”, “d”, “e”, and “f” selected by the user are displayed in this region. On the other hand, the message in the region 32 reads, “PLEASE ENTER LIFTING PASSWORD”, and a lifting password “g” set by the user is displayed in this region. When the OK button 33 is chosen, the keywords “a”, “b”, “c”, “d”, “e”, and “f” are registered in the nonvolatile memory 18. When the OK button 34 is chosen, the lifting password “g” is registered in the nonvolatile memory 18.

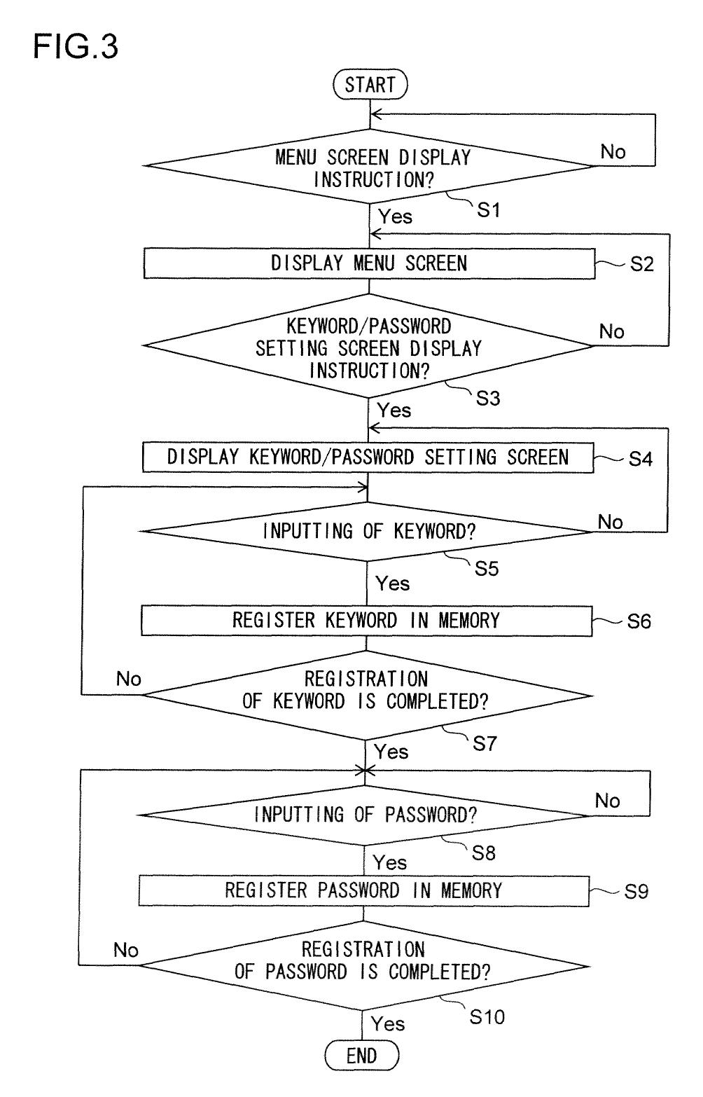

FIG. 3 is a flow chart illustrating the procedure by which a keyword and a password are registered in the embodiment. With reference to this flow chart and FIGS. 1 and 2, the procedure by which a keyword and a password are registered will be described.

First, the user depresses a menu screen display key of the remote controller 27 so as to make the display device 25 display the menu screen. As a result, the CPU 15 of the control portion 19 detects the issuance of a menu screen display instruction (step S1), and reads the menu screen display data previously stored in the nonvolatile memory 18 and feeds it to the OSD signal producing portion 13. The menu screen signal subjected to OSD processing is fed to the video processing portion 14 via the graphic processing portion 11. The video processing portion 14 converts the menu screen signal thus fed into an analog menu screen signal, and feeds the resultant signal to the display device 25. In this way, the display device 25 is made to display the menu screen (step S2).

When the user selects an item for displaying the keyword/password setting screen by operating the remote controller 27 while watching the menu screen, the CPU 15 detects the issuance of a keyword/password setting screen display instruction (step S3), and reads the keyword/password setting screen data previously stored in the nonvolatile memory 18 and feeds it to the OSD signal producing portion 13. The keyword/password setting screen signal subjected to OSD processing is fed to the video processing portion 14 via the graphic processing portion 11. The video processing portion 14 converts the keyword/password setting screen signal thus fed into an analog keyword/password setting screen signal, and feeds the resultant signal to the display device 25. In this way, the display device 25 is made to display the keyword/password setting screen 30 (see FIG. 2) (step S4).

Here, when the user inputs a keyword presumed to be contained in the program name or program information of a program on which the user wishes to impose viewing restrictions by operating the remote controller 27 while watching the keyword/password setting screen 30, and chooses the OK button 33, the keyword registering portion of the CPU 15 detects the inputting of the keywords “a”, “b”, “c”, “d”, “e”, and “f” (step S5), and registers them in the nonvolatile memory 18 (step S6). As a result, the CPU 15 detects the completion of the registration of the keywords “a”, “b”, “c”, “d”, “e”, and “f” (step S7).

Thereafter, when the user inputs a password “g” for lifting viewing restrictions by operating the remote controller 27 while watching the keyword/password setting screen 30, and chooses the OK button 34, the password registering portion of the CPU 15 detects the inputting of the password “g” (step S8), and registers the password “g” in the nonvolatile memory 18 (step S9). As a result, the CPU 15 detects the completion of the registration of the password “g” (step S10). This is the end of the procedures.

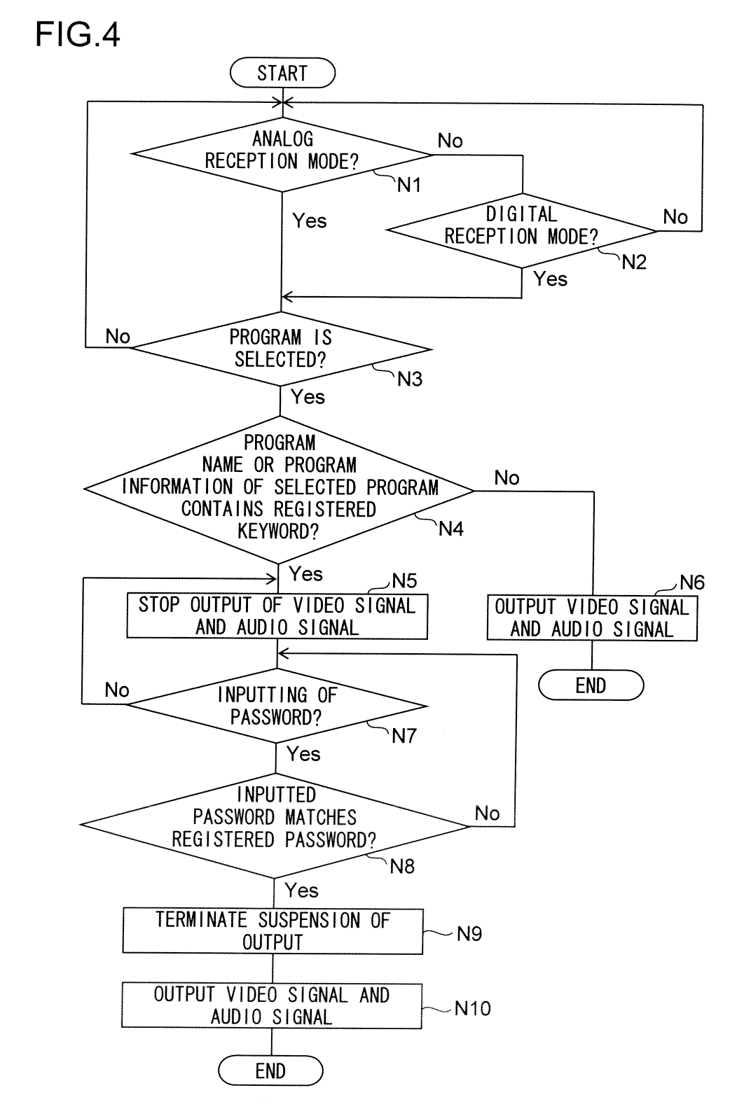

FIG. 4 is a flow chart illustrating video/audio muting processing and unmuting processing in the embodiment. With reference to this flow chart and FIGS. 1 and 2, the video/audio muting processing and the unmuting processing will be described.

In a case where the television station broadcasting a program the user wishes to view is an analog television station, the user sets the broadcast receiving apparatus 100 of the television receiver 1 to an analog reception mode by operating the remote controller 27. As a result, the CPU 15 of the control portion 19 judges that the reception mode is an analog reception mode (step N1). When a channel through which the program the user wishes to view is broadcast is specified, the CPU 15 makes the analog tuner 20 perform channel selection. As a result, the CPU 15 detects the selection of the program (step N3).

On the other hand, in a case where the television station broadcasting a program the user wishes to view is a digital television station, the user sets the broadcast receiving apparatus 100 of the television receiver 1 to a digital reception mode by operating the remote controller 27. As a result, the CPU 15 judges that the reception mode is a digital reception mode (step N2). When a channel through which the program the user wishes to view is broadcast is specified, the CPU 15 makes the digital tuner 9 perform channel selection. As a result, the CPU 15 detects the selection of the program (step N3). Incidentally, selection of a program the user wishes to view may be performed by direct operation of the numeric keys (channel keys) of the remote controller 27, or by operation of the remote controller 27 for the electronic program guide.

Next, the keyword determining portion of the CPU 15 determines whether or not the program name or program information of the selected program contains the keyword registered in the nonvolatile memory 18 (step N4). If it is found that the program name or program information of the selected program contains the keyword registered in the nonvolatile memory 18, the muting portion of the CPU 15 makes the video processing portion 14 and the audio processing portion 12 stop outputting the video signal and the audio signal, respectively (step N5). In this case, the muting portion controls the video processing portion 14 so as not to output the video signal, and controls the audio processing portion 12 so as not to output the audio signal. As a result of this muting processing no video is displayed on the display device 25, and no sound is outputted from the loudspeaker 24.

If it is found that the program name and the program information of the selected program do not contain the keyword registered in the nonvolatile memory 18, the video processing portion 14 and the audio processing portion 12 output the video signal and the audio signal, respectively, as usual (step N6). Therefore, video is displayed on the display device 25, and sound is outputted from the loudspeaker 24.

While the output of the video signal and the audio signal is in a stopped state, if the user transmits a password to the television receiver 1 by operating the remote controller 27, the password determining portion of the CPU 15 detects the inputting of the password (step N7), and determines whether or not the inputted password matches the registered password registered in the nonvolatile memory 18 (step N8).

If it is found that the inputted password matches the registered password, the unmuting portion of the CPU 15 terminates suspension of output by controlling the video processing portion 14 and the audio processing portion 12 so as to output the video signal and the audio signal, respectively (step N9). As a result, the video processing portion 14 outputs the video signal, and the audio processing portion 12 outputs the audio signal (step N10). Consequently, video is displayed on the display device 25, and sound is outputted from the loudspeaker 24.

As described above, according to this embodiment, it is possible to stop the output of the video signal and the audio signal if a program having a program name or program information containing a keyword registered by the user is selected. This makes it possible to block the viewing of a harmful program the user does not want children, for example, to view. Incidentally, it is possible to impose viewing restrictions on a program received by the BS/CS tuner 4 with similar muting processing.

As described above, the invention can be used in a broadcast receiving apparatus including an analog tuner receiving an analog broadcast signal from a selected analog television station and a digital tuner receiving a digital broadcast signal from a selected terrestrial digital television station, the broadcast receiving apparatus being capable of outputting a video/audio signal of an analog broadcast program or a video/audio signal of a digital broadcast program. According to the invention, it is possible to impose viewing restrictions by stopping the output of the video signal and the audio signal.

What is claimed is:

1. A broadcast receiving apparatus comprising:
an analog tuner receiving an analog broadcast signal from a selected analog television station;
a digital tuner receiving a digital broadcast signal from a selected terrestrial digital television station;
video processing system and audio processing system outputting a video/audio signal of an analog broadcast program or a video/audio signal of a digital broadcast program; and
a memory,
wherein the broadcast receiving apparatus comprises:
a keyword registering portion registering a keyword in the memory, the keyword presumed to be contained in a program name or program information of a program on which viewing restrictions are imposed, in response to inputting of the keyword;
a password registering portion registering, in the memory, a password for lifting viewing restrictions imposed on a viewing restricted program in response to inputting of the password;
a keyword determining portion determining, if a program that is receivable by channel selection of the analog tuner or channel selection of the digital tuner is selected by key operation or operation performed for an electronic program guide, whether or not a program name or program information of the selected program contains the keyword registered in the memory; and
a muting portion making the video processing system and the audio processing system stop outputting the video signal and the audio signal, respectively, if the program name or program information of the selected program is found to contain the keyword registered in the memory.

2. The broadcast receiving apparatus of claim 1, further comprising:
a setting screen display portion making a display device display a keyword/password setting screen for registering the keyword and the password in the memory.

3. The broadcast receiving apparatus of claim 1, further comprising:
a password determining portion determining, when detecting inputting of a password by user operation, whether or not the inputted password matches the password registered in the memory; and
an unmuting portion terminating suspension of output of the video signal and the audio signal if the inputted password is found to match the registered password.
